(19) United States
(12) Patent Application Publication
(10) Pub. No.: US 2005/0261955 A1
(43) Pub. Date: Nov. 24, 2005

(54) Film production staff administration system

(76) Inventors: Stephen D. Humble, Richmond, VA (US); Carla S. Rogers, Richmond, VA (US)

Correspondence Address: MATTHEW A. NEWBOLES;STETINA BRUNDA GARRED & BRUCKER, 75 ENTERPRISE, SUITE 250, ALISO VIEJO, CA, 92656, US

(21) Appl. No.: 10/850,670

(22) Filed: May 21, 2004

(51) Int. Cl. G06F 17/60

(52) U.S. Cl. 705/11; 705/1

(57) ABSTRACT

Systems and methods for collecting, storing and updating talent information data related to broadcast productions. A computer network will be provided in connection with software, the latter containing all required forms and paperwork necessary to have union talent, and in particular, performers who are members of either the Screen Actors Guild (“SAG”), the American Federation of Television and Radio Actors (“AFTRA”) or the American Federation of Musicians (AF of M). The software is operative to create a digital job jacket for all forms, contracts and talent details generated in relation to a specific broadcast production. Talent information data is continuously updated during the production process and can be selectively accessed over the computer network by those entities having a need to access such information, such as production companies, casting agencies, paymasters and performers. The systems and methods are operative to substantially eliminate inefficient and error prone practices utilized, as well as serve as a profitable business model.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND OF THE INVENTION

The business practices involved in the production of television and radio commercials, films and related media services are well-known. In this respect, a variety of participants are involved in the production process, the most key of which being advertising agencies, who are responsible for all aspects of the production; production companies that are hired by agencies to produce the media (e.g., commercials, videos, etc.) and are responsible for overseeing subcontractors who cast performers, scout locations, build sets and film the commercial/video under the supervision of the agency's producer; casting agencies that are responsible for helping to find performers to audition for and act in a particular commercial/video; paymasters that provide payroll services and are responsible for paying the performers; performers that audition and are employed as actors or entertainers in the particular production, as well as the agents of such performers; and the unions and associations that represent the performers, and in particular the Screen Actors Guild (“SAG”) and the American Federation of Television and Radio Actors (“AFTRA”), that are responsible for implementing the procedures associated with hiring performers, the compensation to which the performers are entitled, and the dispute resolution process that must be followed to the extent discrepancies are discovered or errors noted in such procedures. Along these lines, it is estimated that there are over thirteen thousand advertising agencies in the U.S. that annually produce an estimated ten thousand to fifteen thousand union television commercials and four thousand to five thousand union radio spots per year.

Despite the well-established entities that are involved in the production process, as well as the respective roles they play, the traditional procedures associated therewith are in some respects grossly ineffective, inefficient, error prone and operative to add considerably to the expense associated with the production. By far the most problematic aspect of such process is the management of information required to employ, compensate and inform the union/association affiliated performers who appear in such productions. In this regard, the current practices of hiring union/association affiliated talent involves substantial recordkeeping and the completion and submission of extremely complex forms, often times within very tight time constraints. Moreover, the forms associated with such process remain essentially paper-based and must be manually prepared, which is known to be expensive, time-consuming and error prone. Exemplary of such forms include principal and extra contracts, production reports, tax forms (W-4 or W-8), Taft Hartley reports, minor's trust account forms, session fee reports, commercial audition reports, actors production time reports, final casting reports, and agency assumption agreements.

Compounding the inefficiencies associated with multiple paper-based forms is the extensive data and detail that must be included in such reports. For example, every performer involved in the production of a commercial, including those who are called to perform but not even cast in the commercial, must be paid and, as a consequence, requires all performers to prepare and distribute a full set of forms whether the performers appear in the “final cut” or not. Moreover, each performer receives a fee for each day he or she is on the production set and to determine the exact amount the performer will be paid is based upon significantly detailed information, such as whether the performer wore his or her own shoes, appears in smoke or worked extra hours, all of which must be included in such current reporting requirements.

Moreover, separate and aside from the documentation associated with the hiring and employment of a performer are the accounting practices that must be followed to compensate such performers following completion of the production. In this regard, each performer appearing in a given commercial will receive a residual payment each time the commercial is aired in perpetuity. Each time the commercial is aired, the advertising agency is obligated to report such airing to the talent paymaster so the performer can receive the appropriate residual payment. As such, to the extent any such discrepancies in the data used by the agency are identified, the paymaster and unions (SAG, AFTRA and the AF of M) must be contacted so that such accounting errors are reported and reconciled. As is well known, in such cases substantial penalties may be imposed by SAG and AFTRA. Moreover, SAG and AFTRA presently require that the performers be paid within fifteen days of their work so data must be submitted and processed in an extremely short time frame. As discussed above, however, because current practices rely upon the manual completion of a multiplicity of complex forms, the same are typically submitted by fax, courier or mail, which also leads to greater inefficiencies and risk for error.

To provide an overview of the current process associated with generating, updating and accessing talent information, the same is shown generally in FIG. 1. Initially, such process 10 begins by the forwarding a commercial audition report 20 by a casting company to an agency, the latter being responsible for the production. Such report 20 is typically in a standard format provided by SAG and AFTRA. Thereafter, in step 30, an agency talent manager prepares paper-based blank contracts for the producer overseeing production. Presently, the agency talent manager must prepare blank contracts for each performer being filmed and thereafter ship the same to the production company hired by the agency to oversee completion of the production. As part of such process, in step 40, there is provided a SAG Actors Production Time Report that is to be filled out by the individual performers and sent with the contracts provided for in step 30, that are sent to the agency at the end of the production.

The agency talent manager compiles the contracts completed above and forwards the same to the talent paymaster along with a production report in step 50. In step 60, the talent paymaster receives the information forwarded in step 50 and reviews the same for accuracy. In particular, the paymaster checks to insure that all performers are properly identified along with correct agent information, if applicable, and creates a session for the agency. The talent paymaster then establishes a payment schedule for the agency based on the information provided in the production report, also as part of step 60. As the production continues, information is further updated regarding the cast utilized in the production along with all other information (such as overtime, wardrobe expenses, fittings, travel, etc.), which must necessarily be provided to the talent paymaster to ensure all payments are made accurately. Such information is further typically provided to the performers, their agents and the unions as shown.

Once the agency completes the production, the agency will send in step 70 a final cast report to the paymaster to finalize the session and identify which of the performers are to be paid residuals for their involvement in the final production. Such final cast report is forwarded in step 80 to the paymaster which updates the session record and prepares to pay residual payments to the various performers based upon media schedules. The agency then provides the media schedules to the paymaster, in step 90, which are either input into the paymaster's system or entered manually by the paymaster into the payment system, with residual payments being made according to set schedules.

In a further series of events, the paymaster will send a union-required report for all the performers involved in the production, along with a standardized SAG production time report. The data forwarded is reviewed in step 100 by either the performer, the performer's agent, or the performer's union to ensure accuracy (as per information forwarded to such entities during production). To the extent an error or discrepancy occurs in step 110, the applicable union must be notified. In such event, a formalized complaint is forwarded in step 120 to the various entities involved in the production, and in particular the agency talent manager, producer, production company, casting agency and/or studio where the claim is researched 130 and resolved 140. To that end, such discrepancy may be resolved through a formal alternative dispute resolution process, the rules and procedure for which are set by either SAG or AFTRA.

As will be readily appreciated, by virtue of the continuous preparation, ongoing compilation and review of the paper-based documents associated with such procedure, substantial discrepancies can and frequently do arise that require tremendous amounts of effort to correct and address on an ongoing basis. As discussed above, virtually all exchange of documents associated with the foregoing process are done by courier, fax, overnight delivery or standard mail. Indeed, such delivery processes in and of themselves are inherently prone to error, are expensive, inefficient, and add substantially to the cost and time associated with generating and keeping track of talent information.

As such, there is a substantial need in the art for an automated, computer-based system and method, and preferably an Internet-based system and method that will be operative to streamline the manner by which information related to union/association affiliate performers employed in broadcast productions is processed and transferred amongst the various entities involved in the production process. Specifically, there is a need for such a system and method that will organize, manage and facilitate the talent-related details of each phase of television and radio production that substantially eliminates the wasteful practices associated with the prior art preparation and transfer of documents associated with such production. Moreover, there is a need for such a system and method that can be readily accessed by all of the participants requiring such information that further enables such information to be archived, readily retrieved, modified and forwarded on with exceedingly minimal effort and nearly precise accuracy. There is a further need in the art for such a system and method that is extremely cost effective, easy to implement, can be modified to readily conform to any and all union requirements associated with the hiring of union performers, and that utilize existing computer-based Internet technology.

### BRIEF SUMMARY OF THE INVENTION

The present invention specifically addresses and alleviates the above-identified deficiencies in the art. In this regard, the present invention is directed to systems and methods for generating, collecting, storing, retrieving and updating data related to union/association talent information required for broadcast productions that advantageously eliminates the inefficient and error prone practices of the prior art, especially in relation to the use of paper-based forms that must be manually prepared, continuously updated, revised and reviewed.

According to a preferred embodiment, the systems and methods will incorporate the use of a computer network, and more preferably an Internet-based system operative to provide an interface between servers and personal computers. Through the use of such network, software will be provided that will be operative to generate and allow for the preparation for all contracts and forms associated with a specific broadcast production. More particularly, such software will be operative to create and allow for the input of data for each and every contract and form as may be required to hire performers for a given production, and will specifically include any and all union-mandated forms, such as those required by SAG, AFTRA and the AF of M. The agency, which will typically be an advertising agency, that is primarily responsible for the broadcast production will utilize the software to create a digital job jacket for all forms, contracts and talent detail for the entire production. Such software will be made available to the production companies and casting agencies to thus enable performer information to be obtained and the necessary forms prepared. In this regard, all such forms will essentially be made available, prepared on line and thereafter stored on a database that can be readily accessed to thus enable the completed forms to be retrieved, copied, forwarded, and updated, as may be necessary. In use, such forms are initially provided to the casting agencies who in turn will make the same available to the various performers at the relevant auditions, whether or not such performers are hired for a given production.

Thereafter, it is contemplated that the performers for a given production will arrive at a filming location where they will electronically enter all pertinent data into the systems of the present invention. When an individual session or shoot day is complete, all pertinent information regarding the day's activities will be uploaded to the system and the job record for each performer immediately updated and sent to the agency for review. Upon agency approval of the data, applicable reports will be sent to the agency, union, performer (as well as the performer's talent agent) and the paymaster. Based on the data provided and transmitted by the agency, the paymaster will initiate the payment to the performer as well as issue invoices to the agency. Once the production is approved, the job record for each of the performers will be revised to reflect the upgrades, downgrades and outgrades of such various performers. All relevant reports will eventually be finalized and distributed as required to thus “close out” the digital job jacket. Thereafter, the data compiled through the systems and methods of the present invention can be continuously accessed and reviewed to assure accurate residual payments and can be further utilized to pass on such relevant information to unions and paymasters, in addition to the agency, to thus facilitate the resolution of any discrepancies and insure timely payment.

Preferably, the data obtained and stored will be job specific (i.e., dedicated to a specific production), and it is contemplated that access limiting means, such as passwords and the like may be utilized to selectively limit access to the data compiled, stored and updated via the present invention. Along these lines, it is contemplated that a hierarchy of access levels may be imposed in the practice of the present invention to thus enable certain entities to provide input, such as the production company or casting company to create an individual session or shoot day within the job record, but simply allow other entities, such as the paymaster, to only access information relevant to the various wages the performers are to be paid.

### BRIEF DESCRIPTION OF THE DRAWINGS

These as well as other features of the present invention will become more apparent upon reference to the drawings.

FIG. 1 is a flow chart diagram illustrating the current process by which talent information (i.e., information related to the performers hired for a specific production) is obtained and disseminated amongst the various entities involved in the production process.

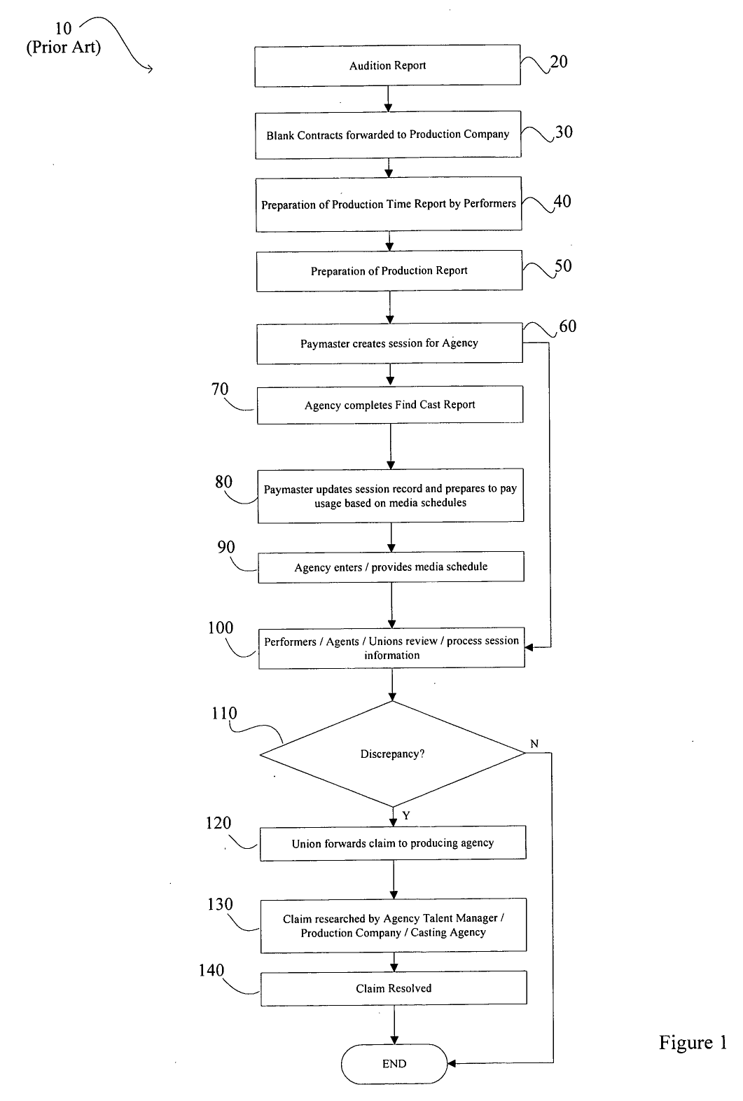

FIG. 2 is a schematic diagram of the system of the present invention and how the same is operative to collect and exchange talent information amongst various entities involved in media production.

FIG. 3 is a flow chart diagram for implementing the methods of the present invention.

### DETAILED DESCRIPTION OF THE INVENTION

The detailed description set forth below is intended as a description of the presently preferred embodiment of the invention, and is not intended to represent the only form in which the present invention may be constructed or utilized. The description sets forth the functions and sequences of steps for constructing and operating the invention. It is to be understood, however, that the same or equivalent functions and sequences may be accomplished by different embodiments and that they are also intended to be encompassed within the scope of the invention.

With respect to the present invention, there is provided a system and method for streamlining the way talent information related to union association/affiliated performers hired as part of the creation of broadcast productions is generated, stored, processed and made accessible to the various entities and organizations involved in the production process. Specifically, the systems and methods will generate, organize, manage and facilitate the talent-related details of each phase of television and radio production. In use, the systems and methods will deploy a computer network, and more particularly, an Internet-based system utilizing a content server, software and related database. As appreciated by millions, the Internet is a system of linked computers that permit fast, low-cost, global communication, entertainment, and information exchange, and hence is the preferred vehicle by which the methods of the present invention may be practiced. As such, the Internet, through interface between servers and personal computers, thus advantageously serves as a primary contact medium by which the systems and methods of the present invention may be practiced. However, while the present invention as described herein is embodied in such a network (i.e., the Internet), it should be understood that the invention is not limited in this respect, and may be embodied in any data communication system wherein data can be generated, stored and retrieved.

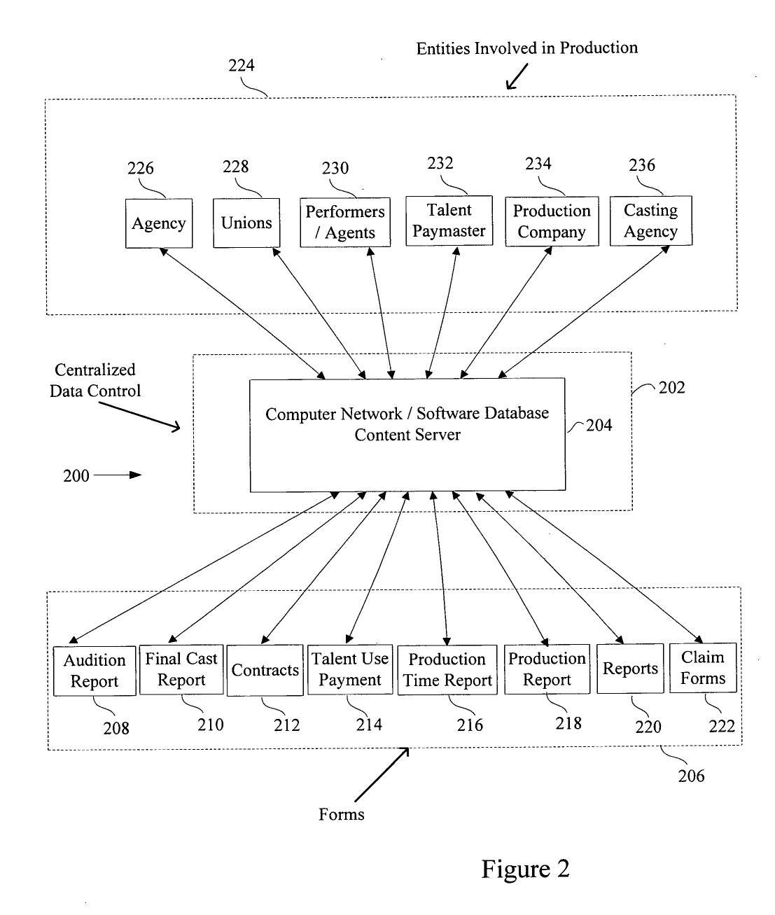

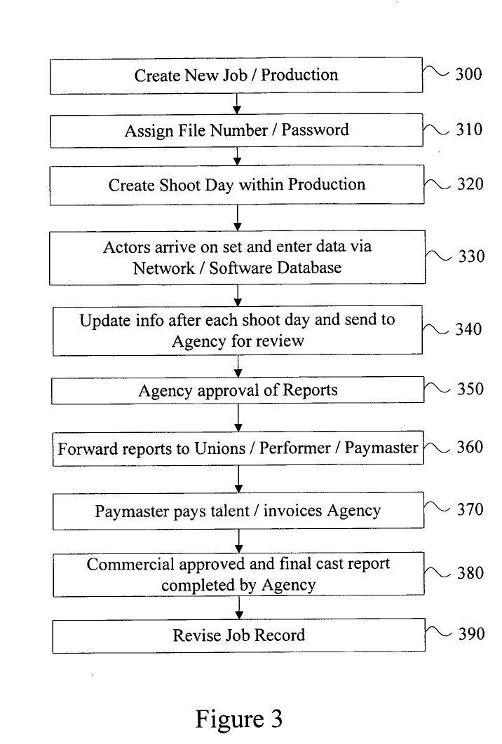

Referring now to FIGS. 2 and 3, and initially to FIG. 2, there is shown a schematic diagram of the system 200 for use in practicing the present invention. Such system 200 utilizes a centralized data control 202 that is comprised of a computer network/software database 204 that will be operative to generate, store, retrieve, modify and forward various types of talent information to the various entities involved in the production, discussed more fully below. It is presently contemplated that the computer network/software database 204 will likely comprise personal computers having access to the Internet. In this regard, such personal computers will access a database via a server that will enable each personal computer to gain access to the various contracts and standardized forms 206 utilized in relation to obtaining, tracking and processing performer talent information. To that end, it is expressly contemplated that software will be provided that will readily allow access to the various standardized documents, forms and contracts utilized to hire performers affiliated with either SAG, AFTRA or AF of M.

Along these lines, it is contemplated that each of the various entities 224 responsible for inputting data, and in particular talent data that must be supplied via the various forms and contracts referenced herein, necessarily requires that such information, as stored within the database, will advantageously be accessible to such entities 224 to enable the same to remotely modify or otherwise update the same. To achieve that end, it is contemplated that a tiered hierarchy of access levels to the database associated with the network 204 will be provided that can be utilized by the various entities 224, whether it be the agency 226, production company 234, paymaster 232, and perhaps most importantly the performers 230 themselves.

Through techniques well-known in the art, each respective entity 224 will be provided with the necessary degree of access to remotely modify, supplement, and/or access information relevant to that particular entity as stored in the database associated with the centralized data control 202 utilized in the practice of the present invention. As an example, the network content server coupled to the database may be selectively accessible utilizing an access or password code that, if valid as recognized by an integrated access mechanism (not shown), will enable the entity, whether it be the agency, production company, paymaster, performer, etc., to be connected to that portion of the database containing the specific information regarding that entity. Such entity, once accessing such relevant information made accessible within the database, may change, retrieve and/or update as appropriate.

As will be recognized by those skilled in the art, numerous methods are available by which secured or limited access may be apportioned to users over such computer network 204, and especially the Internet, and it is contemplated that any of such conventional methodologies may be utilized in providing selective access to the databases utilized in connection with the present invention. Along these lines, it is expressly contemplated that in virtually all applications of the present invention, there will be provided not only first levels of accessibility provided to the various entities that must necessarily retrieve and input data into the database utilized to generate the various forms and information, but that at least one additional layer of access will be provided to ensure proper operation of the content server utilized in connection with the network and the database associated therewith. In this regard, it is contemplated that an overriding mechanism will be provided that can be utilized by a system administrator to monitor activity between the various entities involved in providing, updating, and retrieving data associated with the database of various contracts and forms, but also insure that such entities do not tamper with or otherwise alter the information that has been input into such forms 206, such as information supplied in relation to production time reports, audition reports, and all other applicable documents.

With respect to the latter, it is contemplated that a database of forms 206 will be provided for use in conjunction with other components of the present invention described herein. In one embodiment, such forms 206 can be implemented in accordance with an Adobe Portable Document Format (“PDF”). It will be appreciated by persons skilled in the art that the PDF format is a document format which is supported by the Adobe Acrobat Software family available from Adobe Systems, Inc. Because of the widespread use of the PDF format and the availability of PDF compatible software, the PDF-formatted forms provided in accordance with the present invention can be conveniently viewed by many users across a variety of different operating systems. Other alternatives for maintaining a database of forms will also be readily appreciated by those skilled in the art.

Important in the practice of the present invention is the maintenance of the various forms 206 to be provided in the computer network database 204, which must be continuously updated to ensure that the same comply with all the applicable laws, regulations and union standards. Exemplary of those contracts that will be made readily available in the practice of the present invention principal and extra contracts, production reports, tax forms (W-4, W-8), Taft Hartley reports, minor's trust account forms (to the extent minor performers are sought to be employed), session fee reports, commercial audition reports, actors production time reports, final casting reports, and agency assumption agreements. Along these lines, it is expressly contemplated that all agreements that are mandated by SAG and AFTRA will expressly be included within the practice of the present invention.

Referring not to both FIGS. 2 and 3, there is shown how the systems and methods are operative to streamline the handling of talent information during the making of a broadcast production. Through the system 200, the process is initiated by creating a new job/production file and thereafter assigning a file number and password(s) for the various entities that will be involved in a specific production as shown in FIG. 3. Thereafter, a specific day of filmed production or “shoot day” is created in step 320, and thus is planned in advance. Per conventional practices, an audition report 208 is initially provided that will exist in an electronic format and typically be made available to the casting company/agency 236 responsible for conducting auditions and the like, per conventional practices. In this regard, it is contemplated that the casting company 236 will access the audition report through the computer network/database 204 and complete the report 208 on line utilizing computer input. Once so completed, the audition report 208 can be transmitted electronically through the network 204 to the agency 226 and relevant unions 228. Advantageously, such electronic transmission of the completed audition report 208 has not heretofore been available, and has typically relied on the use of paper-based forms that necessarily had to be delivered by courier. Also, because the audition report 208 will be stored within a database associated with the network 204, the same can be readily accessed and modified as may be necessary.

The system 200 is further operative to provide all relevant contracts 212, which are made available to the agency 226 and in particular the agency talent manager 234 who, in turn, can electronically transmit the same to the production company through the computer network 204. Again, the process is extremely efficient insofar as the document creation is essentially paperless and can be transmitted electronically with virtually no error. Along these lines, it is contemplated that the typical practices of having an agency talent manager prepare contracts for use by the production company for each shoot day may be bypassed altogether by allowing the production company 234 to have complete access to any and all relevant contracts necessary for use in a given production, as well as update all relevant information at the end of each shoot day, as discussed more fully below.

Still further provided by the system of the present invention are the production time report 216 as required by SAG. Such production time reports 216 will likewise be made available in a web page accessible electronic format to the individual performers 230 via the computer network 204, as further shown in step 330 of FIG. 3. Upon completion of such forms, the same may be transmitted electronically to the agency 226 and agency talent manager through the computer network 204. Likewise, the production report 218 for a specific session will likewise be capable of being created and updated in step 340 through the software/database 204 of the present invention to thus enable the production company to readily create the same and forward the same to the appropriate entities, and in particular the agency, in step 350, for approval, and thereafter to the talent paymaster 232 and unions 228 in step 360 through the computer network 204.

With such data, the talent paymaster 232 will be able to readily verify any and all essential information necessary to comply with all regulations regarding the various performers 230 and unions 228 pertinent to the specific production. In this regard, the paymaster 232 will thus be able to set up a session for the agency 226 and proceed to pay the talent and invoice the agency in step 370 through the computer network 204 based solely upon the electronically transmitted production reports 218 it receives.

Along these lines, the system 200 of the present invention will further be operative to provide a final cast report 210, also in electronic format that is capable of being generated and completed by the agency 226, in step 380 of FIG. 3, and thus is able to revise the job record in step 390 to reflect any upgrades, downgrades, or deletions that must necessarily be reflected. Thereafter, the final cast report 210 is forwarded to the paymaster 232 to finalize the specific production. Such final cast report 210 will remain in the computer network database 204 and thereafter be utilized to compensate the performers based upon their involvement in the production. To that end, the system 200 is operative to provide talent use payment information whereby information provided from the agency 226 through the computer network 204 regarding media schedules for the broadcast of the production will be forwarded to the paymaster 232, the latter of which can immediately update the applicable data related to the residual payments to be paid to the various performers 230 appearing in the production. Advantageously, the system 200 of the present invention advantageously allows for talent use payment reports 214 to be readily generated based upon media schedules and the like. Along these lines, by utilizing an electronic means for updating media schedules into a paymaster system, the present system offers substantially greater efficiency and accuracy by eliminating paper-based manual data entry practices typically associated with the updating and entry of media schedule information.

In addition to the foregoing means to streamline the preparation, storage, retrieval and accessibility of talent information associated with the production process, the system 200 of the present invention is also operative to facilitate the resolution of any discrepancies or claim disputes that can arise with regard to the fees paid performers pursuant to SAG and AFTRA regulations. In this regard, the system 200 is further operative to provide in an electronic format the various on-going reports 220 and claim forms 222 utilized in instances where discrepancy or dispute arises. The claim forms 222 will be made available in an electronic format and capable of being completed on line by the various effected entities. In this respect, either the performer or the performer's agent 230 or the unions 228 themselves who, based upon a review of the reports 220, which are likewise made available through the system 200 of the present invention, can utilize such electronic claim form procedure that can be rapidly completed and immediately forwarded to the appropriate agency 226, as well as can make the same available to the various entities involved in the production, and in particular the production company 234, casting agency 236 and/or any other entity involved in the process to thus enable the claim to be more quickly assessed and the discrepancy more timely resolved.

In this regard, it is well-known to those familiar with the current practices that a claim asserted on behalf of a performer typically must be pursued via a formal claim process requiring the submission of a typed claim that, on average, can take months to submit utilizing prior art practices. Such procedure alone is well known to be time consuming, error prone, and expensive, and thus ill-suited to timely resolve fee disputes that can be far more expeditiously resolved utilizing the systems and methods of the present invention. The present invention, however, advantageously expedites this process.

As a further advantage, the systems and methods of the present invention can substantially reduce the penalties that are frequently imposed on agencies due to errors in entering data, and finding and reconciling errors. With respect to the latter, it is well-known that substantial penalties are often imposed and that if the same are the fault of the agency or not discovered until after completion of the project, the same must be borne by the agency and are not reimbursed by the client.

As will additionally be appreciated by those skilled in the art, the systems and methods or the present invention will enable smaller agencies with only one talent manager of business managers that have other responsibilities to be much better equipped to manage their work load. Moreover, large agencies may be able to reduce the number of talent managers currently necessary to process the various forms and paperwork referenced herein, or can otherwise redeploy such resources to other areas of the production process. Such automated system will further be operative to organize the filming sessions associated with the production and save a tremendous amount of time that is otherwise wasted utilizing time-consuming processes of creating and filling out contracts for performers during filming of a commercial. Such information will likewise be far less prone to error and will enable producers to access such valuable information on line to assess the costs to date for a given production.

Further to the foregoing advantages, it is believed that in more highly refined embodiments of the present invention, additional advantages will be readily appreciated. For example, it is contemplated that the systems and methods of the present invention can integrate a time coding feature to document start and end times for performers. In this regard, by tracking dates and times that performers log into the computer network to complete the various forms can serve as evidence as to when and for how long a specific performer was actively involved in filming on a set for a particular shoot day. As is well-known to those skilled in the art, current practices of manually entering such data on paper-based forms currently generates significant errors and disagreements that often require costly resolution efforts.

In a further related enhancement, it is contemplated that each performer, by virtue of being a member of either SAG, AFTRA of the AF of M, will actually be designated a specific number or code, such as a bar code located on a membership card, that can be scanned in and operative to retrieve pertinent information regarding that specific performer to thus eliminate the need to duplicate such information. Such personal tracking information can further be integrated as part of the paymaster obligations to pay such actor. To that end, it is contemplated that the systems and methods of the present invention may further integrate a module to input commercial usage information by the agency or its paymaster directly into the system thereby reducing the costs of the residual tracking and payment process.

Still further, it is contemplated that significant other tools may be developed that will facilitate the ability of the various agencies and other entities involved in the production process to better manage expenses and conserve resources. For example, it is contemplated that a budgeting module or a production calendar may be integrated into the systems and methods of the present invention that is operative to either serve as a reminder or to place limitations to the agency and/or production company when actions should be taken, as well as when to be conscious of budgetary restraints.

It is likewise expressly contemplated that the systems and methods disclosed herein may be utilized as part of a profitable business model wherein the system and methods may be licensed for a fee. Along these lines, it is contemplated that the systems and methods of the present invention could be utilized on a per production basis whereby all aspects related to the documentation and tracking of talent information would be outsourced to an authorized entity who would in turn charge the agency or production company a fee for the use thereof, preferably on a project-by-project basis. Along these lines, given the considerable savings and time efficiency experienced through the practice of the systems and methods of the present invention, the value would be readily appreciated insofar as such systems and methods are operative to substantially reduce error and conserve resources. Accordingly, the commercialization of the systems and methods of the present invention should be readily appreciated by those skilled in the art.

Additional modifications and improvements of the present invention may also be apparent to those of ordinary skill in the art. Thus, the particular combination of parts and steps described and illustrated herein is intended to represent only certain embodiments of the present invention, and is not intended to serve as limitations of alternative devices and methods within the spirit and scope of the invention.

1. A system for generating, storing, retrieving and updating performer related information for a plurality of performers and entities involved in a broadcast production, wherein said performers and entities are connected to a digital computer network carrying and routing digital data between said system and said entities over a communication link, said system comprising:
a) a database for storing a plurality of contracts and forms for use by each respective one of a plurality of performers seeking to audition for and perform in said broadcast production;
b) a server operatively coupled to said database, said server being accessible by said computer network and operative to obtain from said performers information for responding to and completing said contracts and forms stored in said database; and
c) wherein said server is further operative to enable each respective entity to retrieve information provided by said performers responsive to said contracts and forms and selectively enable said entities and said performers to modify the data of each dedicated performer responsive to said contracts and forms stored on said database.

2. The system of claim 1 wherein said contracts and forms stored in said database comprise at least one document selected from the group consisting of a principal contract, and extra contract, a W-4 tax form, a W-9 tax form, a minor's trust account form and an actors production time report.

3. The system of claim 1 wherein said entities involved in said broadcast production comprise an advertising agency, a union/association, a talent paymaster, a production company, and a casting agency.

4. The system of claim 3 wherein said union/association is selected from the group consisting of SAG, AFTRA and the AF of M.

5. The system of claim 4 wherein said database is further operative to provide a plurality of forms to said entities, said plurality of forms being selected from the group consisting of an audition report, a production report, a final cast report, a media schedule, a talent use payment report, and a claim form, said plurality of forms being selectively accessible by each respective entity and capable of being electronically completed thereby over said network.

6. The system of claim 1 wherein said contracts and forms completed by said performers are stored and are transmissible to and from said database in PDF format.

7. A method for generating, storing, retrieving and updating performer related information for a plurality of performers and entities involved in a broadcast production, wherein said performers and entities are connected to a digital computer network carrying and routing digital data between said system and said entities over a communication link, said method comprising:
a) providing a database for storing a multiplicity of contracts and forms for each respective one of a plurality of performers seeking to audition for said broadcast production and a server operatively coupled to said database and accessible by said entities and said performers through said computer network;
b) selectively providing access to each respective performer specified in step (a) to said contracts and forms formed on said database;
c) generating completed contracts and forms from data input from said performers having access to said contracts and forms in step (b)
d) transmitting said completed contracts and forms in step (c) to said database; and
e) selectively allowing access by said entities to said completed documents and forms stored in step (d).

8. The method of claim 7 wherein in step (e), said entities are selected from the group consisting of an agency, an agent, a union/association, a talent paymaster, a production company and a casting agency.

9. The method of claim 8 wherein said union/association is selected from the group consisting of SAG, AFTRA and the AF of M.

10. The method of claim 7 wherein following step (d), the method further comprises the steps:
a) electronically preparing, storing, and updating a production report; and
b) preparing and storing a final cast report.

11. The method of claim 10 wherein said method further comprises the steps electronically generating and storing a talent use payment report.

12. The method of claim 11 wherein said method further comprises the step storing and creating an archive of said audition report, production report, final cast report, and talent use payment report.

13. The method of claim 7 wherein said plurality of contracts and forms comprise at least one form selected from the group consisting of a principal contract, and extra contract, a W-4 tax form, a W-9 tax form, a minor's trust account form, an actors production time report, and a claim form.

14. The system of claim 5 further comprising a data access restriction mechanism operative to selectively permit selective ones of said entities to access said contracts and forms stored in said database.

15. The system of claim 14 wherein said access restriction mechanism comprises a password system.

16. The method of claim 7 wherein in step d), said completed contracts and forms are transmitted in PDF format.
